(19) United States
(12) Patent Application Publication
(10) Pub. No.: US 2023/0396428 A1
(43) Pub. Date: Dec. 7, 2023

(54) SYSTEM AND METHOD OF PROVIDING AN AUTHENTICATOR FOR AN EVENT

(71) Applicant: The University of British Columbia, Vancouver (CA)

(72) Inventors: Dylan GUNN, Vancouver (CA); Ioan ISBASESCU, Vancouver (CA); Dong Ju CHANG, Vancouver (CA); Donney FAN, Vancouver (CA); Dvir HILU, Vancouver (CA)

(21) Appl. No.: 18/203,847

(22) Filed: May 31, 2023

Related U.S. Application Data
(60) Provisional application No. 63/347,675, filed on Jun. 1, 2022.

(51) Int. Cl. H04L 9/08; H04L 9/30; H04L 9/32

(52) U.S. Cl. CPC H04L 9/088; H04L 9/30; H04L 9/3247

(57) ABSTRACT

A method of providing an authenticator for an event includes capturing first information of the event, obtaining a first distillation of the first information of the event. The method also includes digitally signing the first distillation of the information of the event to provide a digitally signed first distillation, and providing the digitally signed first distillation during the event for embedding into the event. The method may include obtaining a recording of the event including a digital signature and a purported first distillation, generating a second distillation of information from the second recording, authenticating the purported first distillation of information utilizing a public key associated with the private key utilized to create the digital signature, and conducting a comparison of the second distillation of the event to the purported first distillation.

### FIELD OF TECHNOLOGY

The present disclosure relates to a system and method for providing an authenticator for an event to facilitate identification of deepfake media.

### BACKGROUND

In the past, high quality recordings such as photos, audio, or video recordings of an “event” were considered an irrefutable and reliable record of the event. Since the popularization of the video camera in the 20th century, video has been the gold standard for evidence of events. However, significant advancements in machine learning (ML) and artificial intelligence are challenging this status quo.

With the advent of deepfake technology, recordings of events are no longer considered irrefutable and reliable records. Deepfakes are video or audio works that are synthesized by machine learning techniques, specifically with the use of generative adversarial networks. This technology facilitates the generation of video footage of any event that appears realistic, such that it is indistinguishable to the human eye whether the event depicted in the video has actually taken place. The synthesis of deepfakes may occur in both videos as well as audio.

Many events are not witnessed directly by the average person, and opinions on the veracity of some events are not formed from firsthand experiences of the event, but rather from media recordings of the event. Deepfakes present problems for both the target or subject of the deepfake, i.e., the entity who is purported to have done or said something, evidenced by an audio or video clip of them doing so, and for the consumer of the deepfake, i.e., the entity watching or listening to the recording and trying to determine the authenticity of the recording.

The use of such deepfakes has increased rapidly, as has awareness of the potential for harm. While some potentially harmful deepfakes have been identified and exposed, future deepfakes are expected to be more sophisticated and more difficult to detect using conventional techniques or analysis.

Deepfakes may be in any of a variety of formats, with more intricate methods in continuous development. The most popular form is face-swap deepfakes, where the face of a target person is swapped with the face of another person, with the intent to convince the viewer the target person has performed some action in the other person's environment. Such deepfakes may be utilized to attack a celebrity's popularity by presenting them in fake scenarios or in non-consensual pornography. Next, in lip-sync deepfakes a target person's facial expressions, especially the lips, are transformed to make them behave believably to a reference audio source. Similarly, puppet-master deepfakes build upon lip-sync deepfakes where entire facial expressions are animated from a reference actor's movements. Lastly, synthesis techniques generate realistic facial expressions or speech in an attempt to create fake profiles or to enhance any of the previous techniques.

With the abundance of social media platforms, people frequently rely on such platforms for information. Without effective methods of detecting deepfakes and preventing their spread, disinformation campaigns may have vast negative implications, such as manipulating elections and fearmongering.

Further, misinformation and disinformation are important issues, impacting many current events, at various scales, from local politics and celebrity gossip, to issues of geopolitical significance. Media companies and platforms are under pressure from government regulators to moderate communication on their networks, and the growing use of deepfakes is expected to bring similar pressure to authenticate content.

Improvements in authentication of media recordings of events are desirable.

### SUMMARY

According to an aspect of an embodiment, a method of providing an authenticator for an event includes capturing first information of the event, obtaining a first distillation of the first information of the event. The method also includes digitally signing the first distillation of the information of the event utilizing a private key to provide a digitally signed first distillation, and providing the digitally signed first distillation during the event for embedding into the event.

A recording of an event including a digital signature and a purported first distillation may be obtained at an electronic device and a second distillation of the information of the event generated from the recording. The purported first distillation of the event is authenticated utilizing a public key associated with the private key utilized to create the digital signature, and a comparison of the second distillation of the event to the purported first distillation is conducted.

According to another aspect, an apparatus for providing an authenticator for an event includes an input device, and a processor coupled to the input device. The processor is configured to receive information of the event, obtain a first distillation of the information of the event, and digitally sign the distillation of the event to provide a digitally signed first distillation. The apparatus also includes a display coupled to the processor, wherein the processor is configured to display, utilizing the display, the digitally signed first distillation.

According to still another aspect, a method of authenticating a recording of an event includes obtaining at an electronic device, the recording of the event including a digital signature and a purported first distillation of the event, generating a second distillation of information from the recording, and authenticating the purported first distillation of information utilizing a public key associated with a private key utilized to create the digital signature. A comparison is conducted of the second distillation of the event to the purported first distillation.

### BRIEF DESCRIPTION OF THE DRAWINGS

Embodiments of the present disclosure will now be described, by way of example only, with reference to the attached Figures, in which:

FIG. 1 is a block diagram illustrating a system for authentication of an event, the system including an apparatus for providing an authenticator of the event in accordance with an aspect of an embodiment;

FIG. 2 is a block diagram illustrating an example of the apparatus for providing an authenticator of FIG. 1;

FIG. 3 is a simplified flowchart illustrating a method of providing an authenticator in accordance with an aspect of an embodiment;

FIG. 4 is a simplified flowchart illustrating a method of authentication utilizing the authenticator provided utilizing the method of FIG. 3;

FIG. 5 is a flowchart illustrating one example of a method of providing an authenticator in accordance with FIG. 3;

FIG. 6 and FIG. 7 illustrate two techniques for dividing speech during speech to text transcription;

FIG. 8 shows a timing diagram of actual captured speech and the speech-text encoded in each QR code;

FIG. 9 is a flowchart illustrating an example of a method of authentication utilizing the authenticator provided in FIG. 5;

FIG. 10 shows a specific example of a software architecture for providing an authenticator of the event in accordance with an aspect of an embodiment.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

Methods that rely on the analysis of artifacts, inconsistencies, or other telltale signs for deepfake detection may ultimately fail as deepfakes become more sophisticated, and may simply lead to an “arms race” between the detection and the generation of deepfakes.

The following describes a method of providing an authenticator for an event that includes capturing first information of the event, obtaining a first distillation of the first information of the event. The method also includes digitally signing the first distillation of the information of the event utilizing a private key to provide a digitally signed first distillation, and providing the digitally signed first distillation during the event for embedding into the event.

A simplified block diagram illustrating a system 100 for authentication of an event. The system 100 includes an apparatus 102 for providing an authenticator of the event in accordance with an aspect of an embodiment. The apparatus 102 may be an electronic device such as a smartphone, a notebook computer, a tablet computer or other device executing computer-readable instructions to generate an authenticator during an event. Alternatively, the apparatus 102 may be a dedicated electronic device. For example, the apparatus 102 may be located close to a speaker or even worn by the speaker during an event to provide the authenticator as output. The authenticator may be a visual authenticator displayed in a machine-readable encoding or may be an audio authenticator output to provide a data encoded sound.

A recording system 104 is illustrated. The recording system 104 is utilized to capture a recording of an event. For example, the recording system 104 may be a digital camera utilized to capture a digital video of the event, including sound, such as a speaker's speech. Alternatively, the recording system may include a voice recorder for recording a speaker's speech. The recording system 104 may be a digital recorder utilized by any person present at the event or even remote from the event, for example, recording a television broadcast of the event. The recording system 104 is utilized to capture a recording of the event and an authenticator provided by the apparatus 102 during the event. Thus, the authenticator is embedded into the recording of the event as the recording system 104 captures the authenticator provided by the apparatus 102.

The recording system 104 is connected to the network 106, directly or indirectly, to provide the recording of the event to a media consumer via the network 106. The network 106 may include a cellular network in addition to the internet or as an alternative to the internet. The network 106 may also include a telecommunication network such as a television network. The apparatus 102 may, optionally, be a dedicated device that is not connected to any network, however.

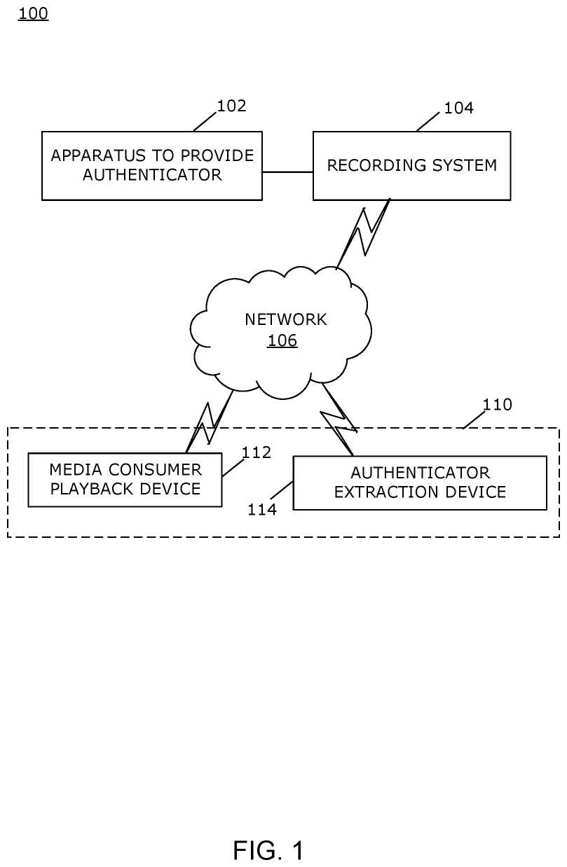

The system 100 for authentication includes a media consumer system 110. As illustrated in FIG. 1, the media consumer system may include a media consumer playback device 112 for playback of the recording of the event, and an authenticator extraction device 114 to obtain the authenticator that is embedded into the recording of the event. Both the media consumer playback device 112 and the authenticator extraction device 114 may be connected, directly or indirectly, to the network 106. For example, the media consumer playback device 112 may be a smartphone, a notebook computer, a tablet computer, a television system, or other device that facilitates playback of the recording of the event may be utilized. The authenticator extraction device 114 may be a smartphone, a notebook computer, a tablet computer or any other suitable device for obtaining the authenticator and utilizing the authenticator to provide an indication of authenticity of the recording.

In one example, the media consumer playback device 112 is a notebook computer that is connected to the network 106 and utilized to obtain a media recording, for example, from a social media platform, or any other source. During playback of the media recording utilizing the notebook computer, a smartphone is utilized as the authenticator extraction device 114 to extract the authenticator embedded in the media played on the media consumer playback device 112. The smartphone also utilizes the media recording as well as the authenticator to provide the indication of authenticity.

Although the media consumer system 110 is described herein as including two different devices including the media consumer playback device 112 and the authenticator extraction device 114, the media consumer system 110 may be a single device configured to carry out the processes of both media playback and authenticator extraction. Thus, the media consumer system 110 may include a single device that receives and facilitates playback of the recording of the event, extracts the authenticator, and determines and provides an indication of authenticity.

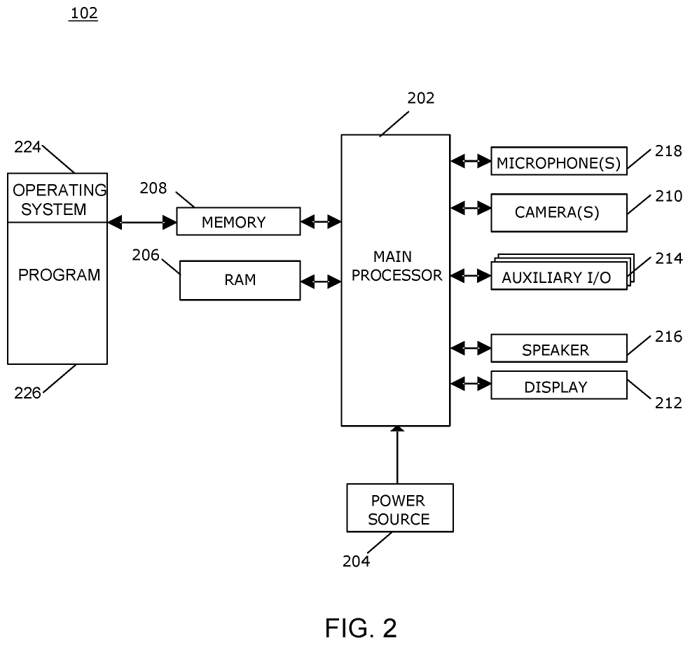

A simplified block diagram illustrating an example of an apparatus 102 for providing an authenticator is shown in FIG. 2. As indicated, the apparatus 102 may be an electronic device such as a smartphone, a notebook computer, a tablet computer or other device executing computer-readable instructions to generate an authenticator during an event. Alternatively, the apparatus 102 may be a dedicated electronic device. A dedicated device without a network connection provides reduced security risk compared to a device with a network connection. FIG. 2 shows a particular example including a processor coupled to memory storing an operating system and program. Other implementations may be successfully implemented.

For the purpose of the example shown in FIG. 2, the apparatus 102 is a dedicated device and includes multiple components, such as a processor 202 that controls the overall operation of the device 102. A power source 204, such as a port to an external power supply or an internal battery, powers the apparatus 102.

The processor 202 interacts with other components, such as a Random Access Memory (RAM) 206, memory 208, one or more cameras 210, a display 212, an auxiliary input/output (I/O) subsystem 214, a speaker 216, and a microphone 218. The speaker 216 is utilized to output audible signals. The auxiliary input/output (I/O) subsystem 214 may include any suitable input or output.

The display 212 may be a touch-sensitive display including touch sensors and a controller for input to the processor 202. Information, such as text, characters, symbols, images, icons, and other items that may be displayed or rendered, is displayed on the display 212 via the processor 202.

In the present example, the apparatus 102 includes an operating system 224 and a software program or application 226 that are executed by the processor 202 and are typically stored in a persistent, updatable store such as the memory 208.

The camera 210 and microphone 218 provide input to the processor 202 as the camera converts images, which includes video, to electrical signals for processing, and the microphone 430 converts audible information into electrical signals for processing by the processor 202. The display 212 and the speaker 216 provide output. The display outputs displayed information and the speaker 428 outputs audible information converted from electrical signals.

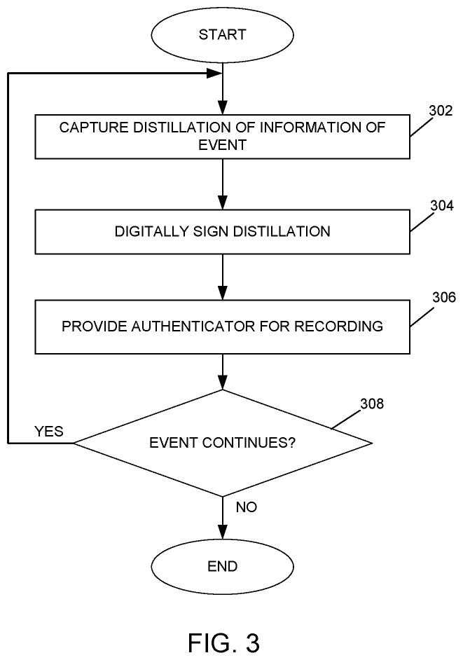

A flowchart illustrating a method of providing an authenticator in accordance with an aspect of an embodiment is shown in FIG. 3. The method may be carried out by software executed, for example, by the apparatus 102. Coding of software for carrying out such a method is within the scope of a person of ordinary skill in the art given the present description. The method may contain additional or fewer processes than shown or described, and may be performed in a different order. Computer-readable code executable by at least one processor, such as the processor 202, to perform the method may be stored in a computer-readable medium, such as a non-transitory computer-readable medium.

The method begins at 302 in which information is captured during an event. The information may be, for example, speech that is received at the microphone 218 and converted to text data, utilizing speech to text transcription software, by the processor 202. Thus, the processor distills information from the event by creating a subset of the information and transforming the information into a format for digitally signing and embedding.

Other information may also be included in the distillation such as a date and time of the event, a location of the event, and other information. In addition, information collected utilizing the camera 210 may be included.

Thus, the distillation includes a subset of the information from an event that is utilized to authenticate meaningful or important aspects of the event. In the example referred to, the text of the speech is considered meaningful or an important aspect of the event. Other aspects may, however, be considered meaningful or important, including or excluding speech. The distillation facilitates digitally signing and embedding by providing the information in a format that may be digitally signed, embedded, and is comparable.

A private key, which may be stored, for example in the memory 208, is then utilized to digitally sign the distilled information at 304. A hash function is performed on the distilled information and the private key and hash are utilized to digitally sign the distillation. The private key may be a private key associated with the apparatus 102, or with a speaker, with an organization, or with the event, for example. The private key is maintained private and not shared. An associated public key, however, may be made available. The public key may be available in a trusted public key source. For example, the public key may be made available on a trusted website, for example in a trusted public key repository, through a trusted email, or through any other suitable method.

The digital signature and the distillation are then provided at 306 as an authenticator. The authenticator therefore includes both the digital signature and the distillation of the event. The digital signature includes an encrypted hash of the distillation. In one example, the digital signature and the distillation may be displayed in the form of a QR code on the display 212 during the event. Alternatively, the authenticator may be output in other suitable forms, including encoding the digital signature and the distillation in an audible form such as a chirp.

As the event continues as determined at 308, the process returns to 302. Thus, as additional speech is received, the process of capturing the information and distilling 302, digitally signing 304, and providing the digital signature and distillation 306 is repeated to update the authenticator during the event. Thus, in the example of the QR code, the displayed QR code is updated throughout the speech.

In the example of the QR code, the display is visible and readable throughout the speech. The apparatus 102 may be, for example a wearable apparatus with a clip such that the speaker clips the apparatus onto their clothing with the display visible during the speech and thus, the QR code is embedded in the speech as the QR code is visible and readable during the speech. Alternatively, chirps may be emitted throughout the speech, thereby embedding the chirps into the speech.

Thus, a media recording of the event captures the authenticator along with the event. In the example of a speech, the speech may be recorded utilizing any suitable recording device. The recording captures the audio from the speaker and the video of the speaker, including the authenticator which includes the digitally signed distillation of the event. Alternatively, a recording captures the video of the speaker as well as the audio from the speaker, including the authenticator in the form of audio output such as chirps.

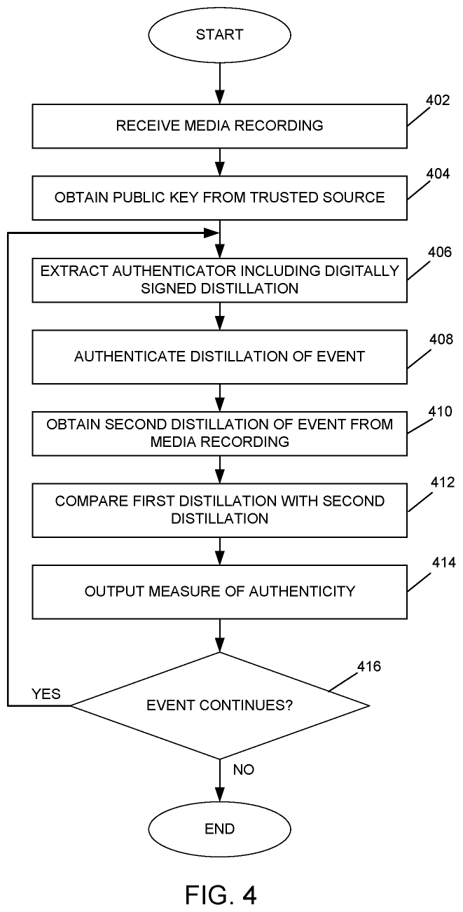

Referring now to FIG. 4, a flowchart illustrating a method of authentication of media played at the media consumer playback device 112, utilizing the authenticator, i.e., the digitally signed distillation of the event, including the digital signature and the distillation of the event, is shown. The method may be carried out by software executed, for example, by a device or devices of the system 110. Coding of software for carrying out such a method is within the scope of a person of ordinary skill in the art given the present description. The method may contain additional or fewer processes than shown or described, and may be performed in a different order. Computer-readable code executable by one or more processors to perform the method may be stored in a computer-readable media.

The media consumer playback device 112 receives a media recording at 402. The media recording may be received in any suitable manner. For example, the media recording may be received in an email, SMS message, or other message communication. Alternatively, the media may be received from a social media platform, or website, in response to a user selection of the video for playback, for example.

The public key that is associated with the private key utilized to digitally sign the distillation is obtained at the authenticator extraction device 114 at 404. The public key may be stored and distributed in any suitable manner. As indicated herein, the public key may be available in a trusted public key source. For example, the public key may be made available on a trusted website, for example in a trusted public key repository, through a trusted email, i.e., an email from a trusted source, or through any other suitable distribution. In a particular example, the speaker at the event makes their public key available through the event website or at a website associated with the speaker. In one example, the speaker is a leader of a country and the public key is available through a government website.

The media recording includes the authenticator embedded in the event. As the media recording is played on the media consumer playback device 112, the authenticator extraction device 114 is utilized to extract the authenticator at 406. The authenticator extraction device 114 may utilize a microphone when executing software to extract the digitally signed distillation in the example in which the authenticator is provided as audio, such as a chirp. Alternatively, the authenticator extraction device 114 may utilize a camera when executing software to extract the authenticator in the example in which authenticator is embedded in the video, for example, as a QR code.

In the example in which the media consumer playback device 112 and the authenticator extraction device 114 are a single device, the extraction may be carried out by a software program executed by a processor, to analyze the video frame by frame to identify and extract the QR code.

The authenticator is utilized to authenticate the distillation utilizing the public key at 408. The public key is utilized to decrypt the hash from the digital signature thus providing the decrypted hash. In addition, a second hash function is performed on the distillation of the event encoded in the authenticator to provide a second hash. The decrypted hash is then compared to the second hash. A match between the decrypted hash and the second hash confirms that the distillation encoded in the authenticator was signed by the private key corresponding to the public key utilized to decrypt the hash. Thus, the distillation of the event encoded in the authenticator such as a QR code, is a purported distillation of the event and hash comparison is utilized to confirm that the purported distillation was signed by the private key that corresponds to the public key utilized to decrypt the hash.

As the media is played on the media consumer playback device 112, the authenticator extraction device 114 also obtains a second distillation of the event at 410, based on the media played. The authenticator extraction device 114 obtains the second distillation by capturing the information during playback of the media recording or as an event is broadcast. As indicated above, the information may be, for example, speech that is received at the microphone 218 and distilled by converting to text data, utilizing speech to text transcription software. Other information, in addition to the text, may also be included in the distilled information at 304 and at 410.

The distillation of the information obtained at 410 is then compared at 412 with the distillation of the information encoded in the authenticator. Thus, information from or relating to the recording that is played is distilled and is compared to the distilled information that is digitally signed and encoded in the authenticator.

Based on the comparison at 412, a measure of authenticity may be provided at 414. The measure of authenticity may be, for example, a score indicative of similarity between the distilled information from or relating to the recording that is played and the distilled information that is from the authenticator. The comparison may identify differences in the two distillations. For example, slight differences may arise as a result of imperfections in speech to text transcription. Thus, the distillations may not be a perfect match even though the media may be an authentic recording of the event. Optionally, metadata from the media recording may be compared to data from the authenticator to facilitate verification of the authenticity of the media recording.

As the media playback continues, the process continues as shown at 416. Thus, the processes of extracting the authenticator at 406, authenticating, obtaining a second distillation at 410, comparing at 412, and outputting a measure of authenticity 414 continues.

In the event of a score indicating significant differences between the distilled information from or relating to the recording that is played and the distilled information that is decrypted from the digitally signed distillation of the event, the video may be considered to be likely tampered with, or a deepfake.

The processes described with reference to FIG. 3 and FIG. 4 may be utilized to provide an authenticator and to provide a measure of authenticity for events not limited to events that include speech recorded on video. The methods may also be applicable in other events, including, for example, audio recorded events, and events captured in photos. Although digital photos do not include temporal data such as speech or gestures, other information such as time, location, and emotion may be utilized as the information that is obtained.

In addition, such processes may also be utilized for videoconferencing and for online identification verification of a person, who is seen signing a document remotely, or other applications in which security is desirable.

The methods described herein may be successfully implemented to authenticate other information from an event, which information is measurable and capable of distillation into a representation that is digitally signed. For example, such information may include biometric data of a person or people in the event, for example, identifying the person, tracking their body state, e.g., agitated, relaxed, healthy, ill, alive, dead, etc. Biometric data may also include physical characteristics such as hair, skin color, iris scans, fingerprints, heart or breathing rhythms, etc.

Such biometric data may be selected to represent a unique biometric signature of a particular person, such as the owner or user of the apparatus to provide the authenticator. Such an implementation would inhibit use of the apparatus by anyone other than the owner of the apparatus.

Other information including pose, orientation, position, or motion of a person or object may also be utilized in the authentication. For example, a speaker's body position or gestures, relative position or interaction of multiple people, or the interaction of people with objects, including interaction with a machine may be tracked and distilled in a representation.

Other information that may be derived from assessments of emotional state, facial expressions, gestures, tone of voice, “body language” etc. may also be successfully distilled and utilized.

The authenticator, including the distillation and the digital signature are described herein as a QR code or audio chirp. The authenticator may take other forms, including a barcode or watermarks. Any other suitable communication signal may be utilized to carry information and in which the distillation and signature are embedded.

Generally, the system and method described herein may be successfully implemented to facilitate deepfake detection for any event and in any type of media. This includes any event for which information from the event is capturable and distillable into a format for digitally signing of the distilled information, and for which the distilled information and the digital signature is presentable such that an observation or recording of the event includes the distilled and digitally signed information.

### EXAMPLE

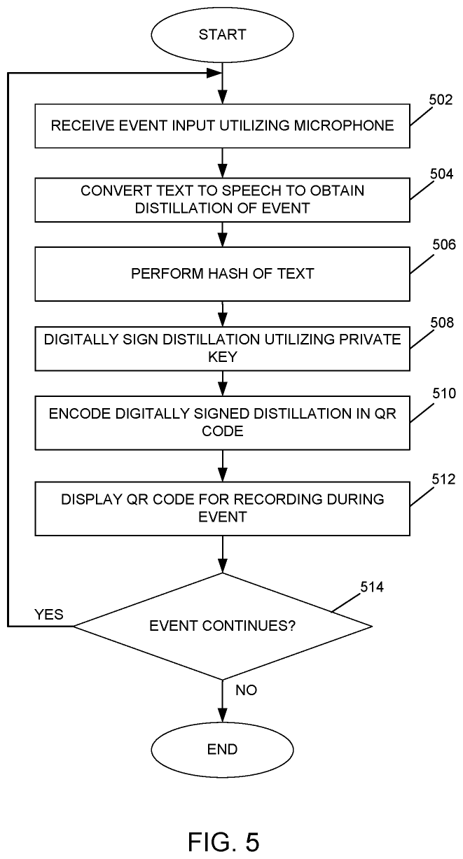

Reference is now made to FIG. 5, which shows a flowchart illustrating a particular example of a method of providing an authenticator. For the purpose of the present example, the event is a speech given by a speaker and the event is recorded on video for distribution, for example, through various news sources and through the internet.

The method of FIG. 5 is carried out in an apparatus 102 for providing an authenticator of the event. The apparatus 102 in this example is a dedicated device. The apparatus 102 is generally lightweight to be worn by the speaker to display information during the speech. While the apparatus may be connected to the network, the apparatus 102 in this example is not connected either directly or indirectly to the network 106 at least during the event to reduce the chance of loss of security of the apparatus 102 during the event. The apparatus 102 includes speech to text software to provide accurate transcription of text from the speech of the speaker.

The apparatus 102 is utilized during the event to receive input utilizing the microphone 218, thus receiving audio of the speech during the event. At 502, the audio from the microphone 218 is received as digital audio data at the processor 202.

The digital audio data is converted by the processor 202, to text data utilizing speech to text software to obtain the distillation of the event, which includes text of the speech at 504.

As indicated, the apparatus in the present example is not connected either directly or indirectly to the network at least during the event. Thus, the speech to text software is integrated into the apparatus 102 and does not rely on a cloud-based Automatic Speech Recognition (ASR) library. The speech to text software executed by the processor 202 is also referred to herein as the speech to text subsystem. Mozilla DeepSpeech™ may be utilized, for example, to achieve real-time performance using Raspberry Pi, providing transcription accuracy that is generally higher than other offline speech to text software, and using generally low memory of about 50 MB or less.

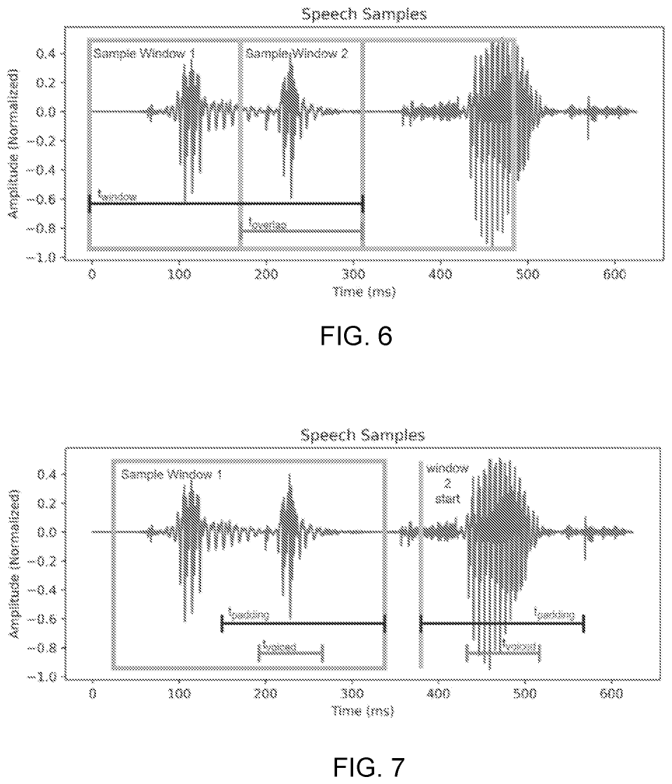

A challenge in the speech to text transcription is to window the audio samples passed to the DeepSpeech™ in the subsystem. DeepSpeech™ transcribes whole words, rather than phonemes. Thus, sample windows end on word boundaries. This is balanced with the need to divide the speech into small enough chunks to maintain a high speech to text transcription throughput. Two techniques for dividing the speech include time windowing, illustrated in FIG. 6 and voice activity detection (VAD) windowing, illustrated in FIG. 7.

In time windowing, the number of transcribed samples for a time window of t_{window} is amplified by the percentage overlap between windows. Samples are constantly transcribed as there is no method of triggering collection. Referring to FIG. 6, samples are sent in windows of a fixed length t_{window}. To avoid problems associated with windows cutting off mid-word, the windows overlap by a time tₒᵥₑᵣₗₐₚ.

In contrast, VAD windowing only sends samples with a significant proportion of “detected speech” to be transcribed, and does not double transcribe samples. As a result, VAD windowing provides significantly higher transcription throughput and is therefore preferred in this context. Referring to FIG. 7, a sliding timeslice of width t_{padding} is continuously analyzed. A webrtcvad Python™ library is utilized to determine which audio frames are considered as “voiced”, marked by t_{activate}. When t_{activate} makes up a threshold proportion of t_{padding}, the timeslice is considered “activated”. The sample window spans the time through which the timeslice is “activated.

A hash function is performed on the text to provide a hash at 506. The hash function maps the text to a fixed size hash. The hash facilitates digitally signing, particularly for text that is very long and improves security, particularly for text that is relatively short.

The distillation of the information is digitally signed using the hash and a private key at 508. Elliptic curve digital signatures have smaller signature sizes for comparable levels of security to, for example, Rivest-Shamier-Adelman (RSA). Thus, the elliptic curve digital signature is more efficient for embedding into a QR code. Elliptic curve digital signature (ECDSA) provides a suitable balance between security and key-size efficiency.

Table 1 shows a comparison of digital signature techniques of RSA, ECDSA—secp256k1, ECDSA—Curve25519, and Rainbow. Despite being less secure than other ECDSAs, secp256k1 may be utilized because of the ease of implementation with Python libraries. Other, more secure digital signature techniques such as Rainbow, which present security against quantum computers, may be successfully implemented however.

TABLE 1
Comparison of Digital Signature Techniques

| | | BCDSA- | ECDSA- | |
|---|---|---|---|---|
| | RSA | secp256k1 | Curve25519 | Rainbow |
| Signature | 512 | 64 | 64 | 66 |
| Size | | | | |
| (bytes) | | | | |
| Security | Low | Low | Medium | High |
| | | | (meets | (secure |
| | | | SafeCorve | against |
| | | | ECC security | quantum |
| | | | requirements) | computers) |
| Efficiency | 1^{st} | 2^{nd} | 3^{rd} | 4^{th} |
| (relative rank) | | | | |
| Peer Reviewed | Python | Python | C/C++ | C/C++ |
| Library Support | | | | |

A QR code is generated with the digitally signed distillation encoded therein at 510.

There is a trade-off between the amount of data that is embedded in a single QR-code and the extractability of that QR code across a variety of different settings, for example, displayed with varied resolution, displayed from a distance, slightly obstructed, or displayed at an angle or on a non-flat surface. A version 8 QR code provides a suitable balance between the amount of information embedded and the extractability across different settings, as determined by analysis.

Table 2 shows the amount of data in the QR code that must be preserved for non-speech data. While a binary representation presents a clear advantage, Python QR code libraries do not provide an easy way to directly encode bits into the QR code, rather taking a string input and applying some internal optimizations. A version 8 QR code with the lowest error correction rate of 7% has room for 279 alphanumeric characters, leaving room for 121 characters of information from the speech-text.

TABLE 2
Non-speech encoded into QR code.

| | Number of | Number |
|---|---|---|
| | Characters | of Bytes |
| Encoded Data | (Alphanumeric) | (Binary) |
| Barcode Frame Number | 4 | 2 |
| Unix Timestamp | 8 | 4 |
| Location Tag | 10 | 5 |
| (Longitude and Latitude | | |
| to 3 Decimal Places) | | |
| Amulet ID | 8 | 4 |
| Signature | 128 | 64 |
| Total Non-Speech | 158 | 79 |

In alphanumeric encoding, the hexadecimal representation of data is converted to a string and encoded as individual characters. In binary encoding, the binary representation is encoded directly.

QR code generation libraries may be utilized and may provide encoding efficiency. A custom encoding may alternatively be utilized for the binary representation directly embedded to the QR code to increase the amount of usable space or characters.

As shown in FIG. 7, space limitations pose a significant problem with VAD sample windowing. In instances in which the speaker speaks continuously without voicing breaks, a large segment of speech is packaged together in a single window. This may exceed the character limit and cause an overflow. Simply passing the overflowing data to the next frame, however, would decrease throughput and cause drifting between the timing when words are spoken and encoded.

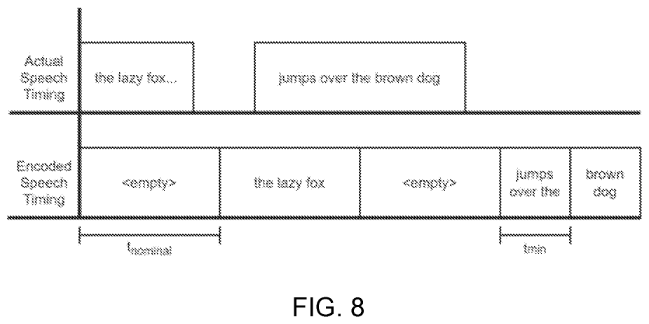

To address this issue, a dynamic refresh rate may be implemented as shown in FIG. 8. On an overflow, the refresh rate is increased while balancing maintaining the real-time performance and the amount of time for which the QR code is displayed at 512 on the display 212 of the apparatus 102.

FIG. 8 shows a timing diagram of actual captured speech at the top of FIG. 8, and the speech-text encoded in each QR code at the bottom. The actual speech is captured in two distinct sample windows of varied length. Short sample windows such as “the lazy fox” may be fully encoded in one QR code. Longer sample windows may be split into two QR code frames, with the refresh rate increasing to maintain real-time performance.

The QR code is displayed on the display 212 of the apparatus 102 during the speech at 512. As the speech continues as determined at 514, the method continues at 502. The QR code is updated during the speech. The time for which the QR code is displayed at 512 depends on the refresh rate.

Because the QR code is displayed on the apparatus 102 which is worn by the speaker, the QR code is recorded in the media recording of the event, referred to herein as embedded in the media recording. Thus, the QR code is displayed and extractable utilizing QR code extraction during the playback of the media recording.

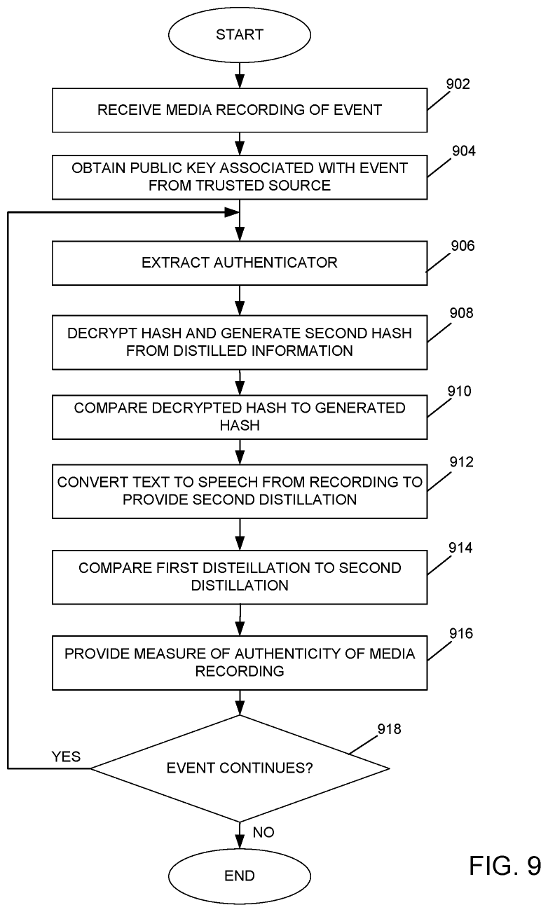

Reference is now made to FIG. 9, which shows a flowchart illustrating a particular example of a method of authentication of the media recording referred to with reference to FIG. 5. As indicated, the QR code generated at 510 is displayed at 512 and the QR code visible and extractable during the media playback at the media consumer playback device 112.

The media may be obtained from any suitable source as indicated, such as a news source or a social media or any other suitable source. The media recording of the event is received at the media consumer playback device 112 at 902, for example, in response to a selection of the media recording on a website or through a social media platform. The media recording of the speech includes the authenticator in the form of the QR code encoding the digitally signed distillation of the event.

The authenticator extraction device 114 is configured to carry out the method for authentication to provide a measure of authenticity of the media recording obtained. Thus, a processor of the authenticator extraction device 114 executes instructions in software to carry out processes of the method of FIG. 9, including processes 904 through 918.

The authenticator extraction device 114 obtains, at 904, the public key associated with the private key that was utilized to digitally sign the distillation of the event.

The processor of the authenticator extraction device 114 executes software on the device, which is also referred to as a verification module to retrieve the public key and to utilize the public key. The module may have a list of public key sources from which the module may retrieve public keys.

In a particular example, the speaker at the event is a world leader and the public key associated with the private key is available through a government website.

As the media recording is played on the media consumer playback device 112, the authenticator extraction device 114, which in the present example, is a smartphone executing software, utilized to extract the authenticator, which in this example is a QR code at 906. A camera of the authenticator extraction device 114 may be utilized by the smartphone executing software to extract the QR code that is visible in the media recording. A suitable QR code detector and extractor that is capable of performing in varied conditions is utilized. The QR code detector and extractor may be in the form of software executed by the processor of the authenticator extraction device 114.

The ML-based QR code detector from WeChat™ as a contributor module to OpenCV may be employed by running inside a browser. This OpenCV WeChatQRCode detector leverages WebAssembly to perform the inference at sufficient speed and provides extraction performance under varied conditions.

The distillation of information that was digitally signed utilizing an elliptic curve digital signature is then authenticated at 908 and 910. To authenticate, the public key obtained at 904 is utilized to decrypt the hash encrypted in the digital signature, providing a decrypted hash at 908. A hash function is also performed on the distilled information that was digitally signed, to provide a second hash. The second hash function that is performed is the same hash function that was previously utilized for the digital signature.

The decrypted hash is then compared to the second hash at 910. A match between the decrypted hash and the second hash confirms that the distillation encoded in the authenticator was signed by the private key corresponding to the public key utilized to decrypt the hash. In the event that the decrypted hash does not match the second hash, the digitally signed distillation is not authentic and cannot be trusted.

As the video is played on the media consumer playback device 112, the authenticator extraction device 114 also obtains a second distillation of the information of the event at 912 by converting the digital audio data from the video, to text utilizing speech to text software at 912. In this case, the speech to text software utilizes the audio input from the video rather than utilizing the microphone as the source input. Cloud processing to provide the speech to text conversion may be utilized. An offline speech to text conversion, however, may be preferred to reduce any risk of tampering.

At 914, the second distillation of information obtained at 912 is then compared with the distillation of the information extracted from the QR code.

Based on the comparison at 914, a score is provided at 916 that is indicative of similarity of the second distillation of information obtained at 912 to the distillation of the information that was digitally signed and encoded in the QR code.

A similarity score indicating a close match indicates that the media is authentic, i.e., not tampered with. On the other hand, a score indicating low or no similarity is an indicator that the media has been tampered with.

Because the speech recognition software may introduce some errors into the transcriptions, the comparison may include the semantic, contextual similarity of the two transcriptions to provide a similarity score.

The contextual matching may be implemented through natural language processing techniques, and, for example, using BERT (Bidirectional Encoder Representations from Transformers). This converts sentences into high dimensional vectors and measures the Euclidean distance between them. Closeness in Euclidean space equates to closeness in semantic meaning. BERT performs this mapping of sentences to vectors in a process referred to as word embedding.

As the media playback continues, the process continues as shown at 918. Thus, the processes of 906 through 916 are repeated.

In the event of a score indicating significant differences between the two distillations of information, the media recording of the event may be considered to be untrustworthy, or likely tampered with.

The authenticator extraction device may be configured to provide feedback to the media consumer as to what aspects of the recording are considered to be an inauthentic recording of the event.

The distillation of the event in the form of text converted from the speech may provide data for comparison and improves the chances of a score indicating close similarity. For example, a bit-by-bit comparison of two digitized audio streams captured by two different microphones may differ due to slight variations in placement and construction of the microphones. A comparison of the text from the audio, however is more likely to be similar. The transcription to text facilitates a comparison of the meaningful aspects of the event while ignoring meaningless artifacts from the placement or construction of the microphones. The distillation may also reduce the size in bits of the information that is compared.

Other information may also be included in the distillation and therefore in the QR code or chirp. Information such as the time and location from the metadata of the video may be utilized in the comparison to the distilled information in the QR code or chirp. This additional information facilitates meaningful comparison when there are slight differences in the two distillations of the event that are a result of, for example, slight differences or errors in the speech to text transcription.

Furthermore, information such as tone of voice or inflection, facial expression, body pose, or movement of the body, head, or eyes may be included utilizing tracking technology to capture such information.

A trusted source is utilized for the public key. Examples of public key sources described herein include a trusted website, a trusted public key repository, or a trusted email, i.e., an email from a trusted source. For example, a signature line in an email from an individual or entity may include a public key for events associated with that individual or entity.

Optionally, a certificate authority may be utilized to issue digital certificates. Such certificates include a public key, the details of the owner of the public key such as the name, organization, address, country, and so forth. Such certificates also include a validity period of the certificate and the digital signature from the Certificate Authority.

A trusted certificate authority may be utilized to provide a trusted public key associated with or belonging to a person on the certificate. In this case, trust is not established directly but is indirectly established through a trusted certificate authority. Thus, a certificate authority may be implemented for the purpose of use with the present methods. Generation of a root certificate authority and issuing certificates may be accomplished using Open SSL.

As indicated, the processes described herein may be carried out by software executed by processors of the apparatus and systems described herein. The processes may be carried out by devices utilizing various platforms such as Android, iOS, Windows, macOS, or Linux. The software may take the form of applications built on a web browser for example. Building on a web browser is advantageous in providing good user experience while utilizing existing hardware apparatus, systems, and devices of the apparatus and systems. In addition, one or more of the modules, including the verification module may take the form of a browser extension. This enables leveraging of the browser's built in APIs as well as ensuring that the module is active when a user visits a website. Utilizing WebAssembly also provides performance that is close to native speed.

Reference is made herein to the use of OpenCV. Custom machine learning applications may be utilized in a browser environment, however.

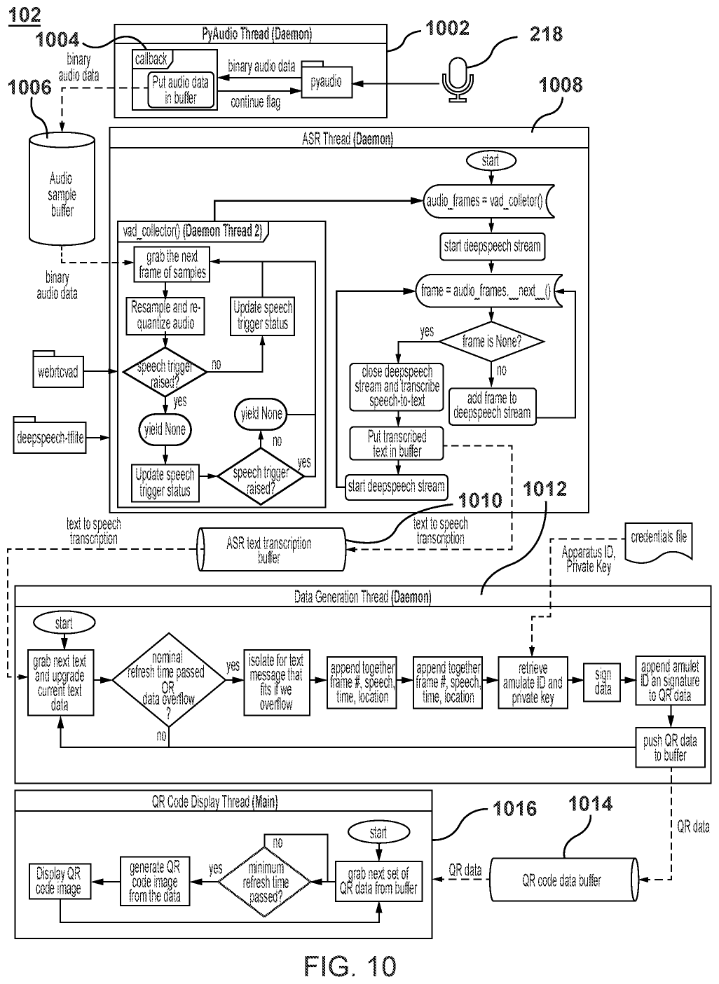

FIG. 10 shows a specific example of a software architecture of the apparatus 102 for providing an authenticator of the event. As is shown in FIG. 10, audio samples for the automatic speech recognition (ASR) pipeline are collected using the PyAudio library. PyAudio runs a daemon 1002, or background, thread referred to as the PyAudio Thread, which continuously monitors input from the microphone 218 and triggers a callback 1004 when new samples are passed in.

The callback 1004 is short to ensure no samples are missed, and simply passes the audio samples to a buffer 1006 for processing. Once samples are in the buffer 1006, a second daemon thread 1008, referred to as an ASR Thread, grabs the audio samples, transcribes them utilizing speech to text, and passes the text to a second buffer 1010.

A third daemon thread 1012, referred to as the Data Generation Thread collects text transcriptions coming from the ASR Thread and packages together the data to be encoded in the QR-code. This thread continues to collect text until the nominal refresh time period has passed, and then pushes the signed QR-code data into a third buffer 1014. If the data is set to produce an overflow, the thread splits the text data on a word boundary and pushes it to the buffer 1014 as soon as the overflow is detected.

Lastly, the main application thread 1016, referred to as the QR Code Display Thread grabs the signed data and generates the QR-code image, which is displayed. If there are no overflows, data arrives and displays at the nominal refresh rate.

In the case of overflows, data may arrive on machine time scales. To reduce the chance of the QR code from refreshing too quickly, the thread waits for the minimal refresh period to pass before displaying the QR code. The minimum refresh time ensures the QR code frame is displayed long enough for the verification system to extract it while still maintaining system throughput and inhibiting drift.

With the information such as the QR code displayed in close proximity or even on the speaker, the QR code is easily captured, referred to as embedded, in a video recording of the speaker. In an alternative embodiment, a short chirp may be utilized to provide an audio stream of a signed distillation. The chirp may be short such that the chirp does not significantly interrupt the speech.

Similarly, the chirp may be emitted in close proximity to the speaker such that the chirp is captured by any audio recording. Thus, the distillation of the event is embedded into video or audio as a 2D barcode or QR code, or as a chirp. Authenticity of any recording of the speech may therefore be determined.

The description refers to distilling by capturing speech audio and converting that audio to text, followed by digitally signing the distilled text and displaying in a 2D barcode. The 2D barcode is updated every few seconds for example, as the speech continues.

The processes described herein may be successfully implemented for other media, rather than just video. Information from other media such as audio recordings may also be distilled, digitally signed, and embedded in the media from any event.

In future applications, devices may include a dedicated channel for the distillation for a variety of reasons, one of which would be to ensure the distillation is not compromised by repeated sampling, filtering, or compressions as it is posted and shared across multiple distribution platforms.

Recordings may also be encoded in the blockchain to provide an immutable record of the recording.

The processes described herein may also be successfully implemented in relation to virtual reality events and may be utilized to confirm actions in a virtual world are driven by actions in the real world.

The methods and apparatus described herein may be utilized by an individual, group, or organization, to inhibit misrepresentation or attack by deepfakes. Thus, for example, a speaker may utilize an authenticator when that person believes that they may be recorded. The media consumer on the other hand may be suspicious of any recording unless the recording includes an authenticator and the authentication of the recording is successfully completed.

In another example, a person, group, or organization may provide to another person, the apparatus to provide an authenticator. This apparatus may then be utilized to enable authentication of any future remote interactions such as videoconferencing that may otherwise be subject to deepfake attack. This may be useful, for example, where the organization providing the apparatus is a bank and the person is a client of the bank.

The apparatus to provide the authenticator may also be utilized as a “proxy witness” to an event. For example, the apparatus owner may provide the apparatus at or included in an event to ensure that a trusted authentic record is provided.

In addition, multiple private/public key pairs may be successfully implemented. For example, two people may each provide a private key to digitally sign the distillation generated by the apparatus to provide the authenticator.

Advantageously, the media consumer is provided with confidence in authenticity or lack of authenticity of the media consumed based on the comparison carried out and the score provided by the authenticator extraction device 114. Only the private key associated with the wearer of the apparatus 102 for providing the authenticator or associated with the apparatus 102 may be utilized to digitally sign the distilled data, which may be distilled text from the speech such that the consumer is able to decrypt using the trusted associated public key. Without the use of the private key to encrypt, the QR code cannot be authenticated by a consumer with the public key associated with that private key. Modified QR codes will result in a score indicating significant differences in the distilled information, thus failing the authentication.

The authenticator and the method described herein provides the user with “trustless” or “trust-free” protection from a deepfake attack. Utilizing the method described, there is no reliance on guarantees of security, authenticity, media provenance, etc. from any parties in the media recording or distribution. In addition, the method may be utilized by the user without an understanding of the technologies or systems utilized in the media recording, processing, distribution, or consumption process.

As indicated above, the system and method described herein may be successfully implemented to facilitate deepfake detection for any event and in any type of media for which information from the event is capturable and distillable into a format for digitally signing, and for which the distilled information and the digital signature is presentable such that any observation or recording of the event includes the distilled and digitally signed information.

The described embodiments are to be considered as illustrative and not restrictive. The scope of the claims should not be limited by the preferred embodiments set forth in the examples, but should be given the broadest interpretation consistent with the description as a whole. All changes that come with meaning and range of equivalency of the claims are to be embraced within their scope.

1. A method of providing an authenticator for an event, the method comprising:
capturing first information of the event;
obtaining a first distillation of the first information of the event;
digitally signing the first distillation of the information of the event utilizing a private key, to provide a digitally signed first distillation;
providing the digitally signed first distillation during the event for embedding into the event.

2. The method according to claim 1, wherein capturing the first information comprises obtaining a portion of the information during the event.

3. The method according to claim 1, wherein the event includes a speaker and capturing the first information comprises obtaining a portion of the speech, wherein obtaining a first distillation of the first information comprises converting the portion of the speech to text utilizing voice to text.

4. The method according to claim 1, wherein providing the digitally signed distillation comprises displaying the digitally signed distillation in machine-readable encoding during the event.

5. The method according to claim 1, wherein providing the digitally signed distillation comprises providing the digitally signed distillation encoded as digital audio during the event.

6. The method according to claim 1, wherein the process of capturing the first information, obtaining the first distillation, digitally signing, and providing are repeated during the event to update the first information and the digitally signed first distillation as the event continues.

7. The method according to claim 1, wherein providing the digitally signed distillation comprises encoding the digitally signed first distillation in a QR code.

8. The method according to claim 1, wherein providing the digitally signed distillation comprises encoding the digitally signed first distillation in an audio chirp.

9. The method according to claim 1, comprising:
obtaining at an electronic device, a recording of the event including a digital signature and a purported first distillation;
generating a second distillation of information from the second recording;
authenticating the purported first distillation of information utilizing a public key associated with the private key utilized to create the digital signature;
conducting a comparison of the second distillation of the event to the purported first distillation.

10. The method according to claim 9, wherein authenticating the purported first distillation of information comprises obtaining a first hash from the digital signature, conducting a second hash function on the purported first distillation to provide a second hash and comparing the first hash to the second hash.

11. The method according to claim 9, wherein the event includes a speaker and generating the second distillation of the information comprises obtaining a speech portion from the second recording and converting the speech portion from the second recording to text utilizing speech to text.

12. The method according to claim 9, comprising obtaining the public key from a trusted public key source prior to decrypting.

13. The method according to claim 12, wherein obtaining the public key comprises obtaining the public key from a public key repository.

14. The method according to claim 9, comprising determining, based on the comparison of the second distillation of the event to the first distillation, a measure of similarity between the event and the recording.

15. The method according to claim 14, wherein the measure of similarity is utilized to determine if the recording of the event is an authentic recording of the event.

16. An apparatus for providing an authenticator for an event, the apparatus comprising:
an input device;
a processor coupled to the input device and configured to:
receive information of the event;
obtain a distillation of the information of the event;
digitally sign the distillation of the event to provide a digitally signed first distillation;
encode the digitally signed first distillation into a machine-readable encoding; and
a display coupled to the processor, wherein the processor is configured to display, utilizing the display, encoding of the digitally signed first distillation.

17. The apparatus according to claim 16, wherein the input device comprises a microphone and the information received comprises speech.

18. The apparatus according to claim 17, wherein the processor is configured to convert speech to text and the first distillation of the information comprises text transcribed from speech.

19. The apparatus according to claim 17, wherein the processor is configured to repeatedly receive the information, obtain the distillation, and digitally sign the distillation during the event to repeatedly update the digitally signed distillation.

20. The apparatus according to claim 17, wherein the digitally signed distillation is encoded in a QR code and the display is configured to display the QR code.

21. A method of authenticating a recording of an event, the method comprising:
obtaining at an electronic device, the recording of the event including a digital signature and a purported first distillation of the event;
generating a second distillation of information from the recording;
authenticating the purported first distillation of information utilizing a public key associated with a private key utilized to create the digital signature;
conducting a comparison of the second distillation of the event to the purported first distillation.

22. The method according to claim 21, wherein authenticating the purported first distillation of information comprises obtaining a first hash from the digital signature and comparing the first hash to a second hash generated by conducting a hash function on the purported first distillation of information, which hash function is the same as that conducted to generate the first hash.

23. The method according to claim 21, wherein the event includes a speaker and generating the second distillation of the information comprises obtaining a speech portion from the second recording and converting the speech portion from the second recording to text utilizing speech to text.

24. The method according to claim 22, comprising obtaining the public key from a trusted public key source prior to decrypting.

25. The method according to claim 24, wherein obtaining the public key comprises obtaining the public key from a public key repository.

26. The method according to claim 22, comprising determining, based on the comparison of the second distillation of the event to the first distillation, a measure of similarity between the event and the recording.

27. The method according to claim 26, wherein the measure of similarity is utilized to determine if the recording is an authentic recording of the event.
